(19) United States
(12) Patent Application Publication
(10) Pub. No.: US 2005/0017469 A1
(43) Pub. Date: Jan. 27, 2005

(54) Multifunction stroller

(76) Inventors: William R. Hill, Placerville, CA (US); Chad Christensen, Meridian, ID (US)

Correspondence Address: Richard C. Litman;LITMAN LAW OFFICES, LTD., P.O. Box 15035, Arlington, VA, 22215, US

(21) Appl. No.: 10/622,505

(22) Filed: Jul. 21, 2003

(51) Int. Cl. B62B 7/00; B62B 9/00

(52) U.S. Cl. 280/47.38

(57) ABSTRACT

The multifunction stroller has a three-wheeled frame with a child's seat and a leg shroud mounted thereon. The stroller has a spoiler, or wide thin plate describing a 90° arc extending rearward. The spoiler terminates in an inverted, U-shaped channel, which may be clamped to a front rail of a second stroller, or which may receive a handlebar assembly for use as a stand alone stroller. Alternately, a planar plate terminating in a U-shaped channel may be attached to the rear of the stroller frame and used to couple the multifunction stroller to a grocery cart. The multifunction stroller may be used as a child's push toy with or without the handlebar assembly.

### BACKGROUND OF THE INVENTION

1. Field of the Invention

The present invention relates generally to strollers, and particularly to a multifunction stroller which may be attached to another stroller or grocery cart and pushed in tandem, used as a stand alone stroller, or used as a child's push toy.

2. Description of the Related Art

A number of strollers and attachments related thereto have been devised carrying and transporting a child or children. The classic baby stroller is a four-wheeled, single seat vehicle with a handle extending to the rear which may be pushed by the parent, thereby relieving the strain of carrying the child in one's arms. The basic stroller is often expanded by providing two seats, either laterally or in column, to accommodate twins. Related devices include a cart-style child carrier that is attached to the rear of a bicycle so that it may be pulled by the bicyclist. None of these devices, however, is a multifunction device designed to be adapted for attaching to the front end of either another stroller or a grocery cart in order to be pushed in tandem, or to be used as a stand alone stroller, or to be used as a child's push toy.

For example, U.S. Design Pat. No. 360,392, issued Jul. 18, 1995 to Lewandowski, shows a double stroller having two seats mounted upon a frame of a cart-like vehicle. U.S. Design Pat. No. 394,831, issued Jun. 2, 1998 to Polak et al., shows a tandem stroller having a pair of front wheels, a pair of rear wheels, a pair of opposing seats mounted upon a platform, and a handle bar at both front and rear ends of the stroller.

U.S. Patent Application Publication No. 2003/0025304, published Feb. 6, 2003 to Haeggberg, describes a trailer that is designed to transport at least one child and can be attached to a stroller. The trailer is designed so that the trailer is connected to the frame of the stroller, is equipped with a seat, and is fitted with at least one handle, at least one foot rest and a coupling device consisting of an attachment assembly and a first and a second joint.

U.S. Pat. No. 2,426,432, issued Aug. 26, 1947 to Breckner et al., describes a child's vehicle for use as a stroller or go-cart and which may be readily converted to a child's walker. The vehicle includes a wheeled chassis, a straddle seat unit, a removable floor-pan, longitudinal frame members, and a removable propulsive handle.

U.S. Pat. No. 4,969,656, issued Nov. 13, 1990 to Clausen, describes a multi-place stroller having a series of seats at cutout areas in a tray supported on columns secured to a wheeled floor panel. A tongue is also secured to the floor panel.

U.S. Pat. No. 5,076,599, issued Dec. 31, 1991 to Lockett et al., describes a convertible combined stroller and trailer which can be changed from a stroller mode to a trailer mode and vice versa. When the vehicle is in either the stroller mode or trailer mode, it includes a flexible seat for one or more passenger. When used in a stroller mode, rear wheels are attached to the opposite sides of the rear of the frame at a position called “Position S” and front wheels are attached to the opposite sides of the front of the frame. At this position, the load on the frame is distributed evenly on the rear wheels and on the front wheel. When the vehicle is in a trailer mode the front wheels are removed, the rear wheels are moved from the “Position S” to a position forward and upward on the sides of the frame called “Position T”, and one end of a tow bar is attached to the front of the vehicle frame. Another end of the tow bar is attached to the rear of a towing vehicle, such as a bicycle frame. In the trailer mode, the load on the frame is evenly distributed on the rear tires, while the front of the frame and tow bar carry very little load.

U.S. Pat. No. 5,312,122, issued May 17, 1994 to Doty, describes a plurality of shopping cart attachments for facilitating the operation and improving the child carrying capabilities of existing shopping carts. The shopping cart attachments include a tandem child seat system for converting a shopping cart into a tandem shopping cart, a back guard/harness system for preventing a child from standing up and/or turning around while in a shopping cart child seat, and a protective cart clip system for preventing a child from coming into contact with the germ laden handlebar area of a shopping cart.

U.S. Pat. No. 5,511,802, issued Apr. 30, 1996 to Aitken, describes a single wheel running stroller for carrying a child. The running stroller has a large front wheel with a U-shaped frame, foot supports for receiving the child's feet, and a curved main frame member which extends from the U-shaped frame to a handle at the upper end thereof. A waist band bracket is attached with a universal joint to the main frame member of the stroller, and the waist band fits around the user's waist to drive and stabilize the device.

U.S. Pat. No. 5,848,797, issued Dec. 15, 1998 to Paez, describes a child's safety seat for attachment to the rear of a conventional shopping cart. A U-shaped restraining bar wraps about the front of the seat and includes a release knob. The safety seat includes a pair of vertical height adjustable telescoping legs with swivel wheels underneath. The vertical legs can be attached to one another and be attached to legs on the shopping cart by a novel length adjustable sandwiching clasp.

U.S. Pat. No. 5,882,021, issued Mar. 16, 1999 to Reiland, et al., describes a child carrier accessory attached to the rear end of a vehicle, such as a shopping cart. The child carrier accessory has a platform preferably supported by a pair of preferably swivel caster wheels. A carrier body located on the platform contains a seat portion with a center divider to form left and right seat areas. A carrier handle is provided on a back side of the carrier body for pushing the combination child carrier accessory and shopping cart.

U.S. Pat. No. 5,884,920, issued Mar. 23, 1999 to Seto, describes a vehicle for transporting loads over rough terrain having a seat mounted on a bracket which is mounted on a frame which rides on a single wheel carried within a fork. A handlebar with vertical handgrips provides control in a variety of positions in use, and a pair of normally retracted wheels which can be extended to stabilize the vehicle.

U.S. Pat. No. 6,231,056, issued May 15, 2001 to Wu, describes a dual function baby walker, wherein a supporting frame is mounted at the top of a base seat body which is disposed to the bottom of an upper housing seat including a chamber. When the chamber at the upper housing seat is provided with a chair, the baby can be seated on the chair and the legs of the baby can touch the ground to control the moving direction of the walker. When the baby is standing up, the upper housing seat can be detached from the supporting frame, and the bottom of the upper housing seat is mounted with a plurality of wheel bodies. The top of the upper housing seat is provided with a handle to provide holding for the baby while walking. Thus, the baby walker is suitable to be used for baby at different growth stages such that the baby walker can be functioned as a sitting type of baby walker and a pushing type of baby walker as well.

U.S. Pat. No. 6,443,469, issued Sep. 3, 2002 to Cross et al., describes a child stroller apparatus for allowing the child to either ride in the seat member or upon a seat just like a bicycle. The child stroller apparatus includes a seat assembly, a storage member depending from the seat assembly, a rear wheel assembly being mounted to the storage member, a canopy member being removably mounted to the seat assembly, a handle assembly including a handle member being securely attached to the seat assembly, a bicycle frame assembly being securely attached to the storage member, a seat member being mounted upon the bicycle frame assembly, and a steering assembly being attached to the bicycle frame assembly.

None of the above inventions and patents, taken either singly or in combination, is seen to describe the instant invention as claimed. Thus, a multifunction stroller that may be attached to the front end of another stroller or a grocery cart in order to be pushed in tandem, that may be used as a stand alone stroller, or that may be used as a child's push toy, is desired.

### SUMMARY OF THE INVENTION

The multifunction stroller has a three-wheeled frame with a child's seat and a leg shroud mounted thereon. The stroller has a spoiler, or wide thin plate describing a 90° arc extending rearward. The spoiler terminates in an inverted, U-shaped channel, which may be clamped to a front rail of a second stroller, or which may receive a handlebar assembly for use as a stand alone stroller. Alternately, a planar plate terminating in a U-shaped channel may be attached to the rear of the stroller frame and used to couple the multifunction stroller to a grocery cart. The multifunction stroller may be used as a child's push toy with or without the handlebar assembly.

The rear wheel assembly includes two wheels mounted on a common axle, while the front end of the frame is supported on a single caster wheel. The rear wheel assembly is attached to the frame by a pair of hand-operated threaded knobs, so that the rear wheel assembly is easily removed when the multifunction stroller is attached as the front end of a tandem push vehicle, the rear end being raised off the ground.

The seat may be mounted to the platform by a track and runner assembly, similar to that used in automobiles, in order to adjust the seat forward and rearward to accommodate the length of the child's legs. The seat may also have a hinged backrest, so that the backrest can be lowered for compact storage and transport. The seat is preferably equipped with a seat belt or shoulder harness for safely restraining the child in the stroller.

A pseudo- or simulated steering wheel, not connected to a steering mechanism, may be attached to the leg shroud for the child's amusement.

Accordingly, it is a principal object of the invention to provide a multifunction stroller having a rear spoiler attachable to the front end of a second stroller for use as part of a tandem stroller assembly.

It is another object of the invention to provide a multifunction stroller having a rear spoiler capable of receiving a handlebar assembly for use as a stand alone stroller.

It is a further object of the invention to provide a multifunction stroller attachable to the front end of a grocery cart so that the grocery cart and stroller can be pushed in unison.

Still another object of the invention is to provide a multifunction stroller which is convertible for use in tandem with a second stroller or a grocery cart, which can be used as a stand alone stroller, and which may be used as a child's push toy.

It is an object of the invention to provide improved elements and arrangements thereof in a multifunction stroller for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a multifunction stroller according to the present invention.

FIG. 2 is an exploded, perspective view of the multifunction stroller according to the present invention.

FIG. 3 is an environmental, perspective, view of the multifunction stroller of the present invention attached in tandem to a second stroller.

FIG. 4 is a section view along lines 4-4 of FIG. 3.

FIG. 5 is an environmental, perspective, view of the multifunction stroller according to the present invention attached in tandem with a grocery cart.

FIG. 6 is a section view taken along lines 6-6 of FIG. 5.

FIG. 7 is an environmental, perspective view of the multifunction stroller of the present invention with a handlebar assembly attached for use as a stand alone stroller.

FIG. 8 is an environmental, perspective, view of the multifunction stroller in use as a push toy.

Similar reference characters denote corresponding features consistently throughout the attached drawings.

### DETAILED DESCRIPTION OF THE PREFERRED EMBODIMENTS

The multifunction stroller of the present invention, designated generally as 10 in the drawings, is a multipurpose stroller which is capable of being used as a stand alone stroller, or of being attached to a second stroller of grocery cart for operation in tandem. The multifunction stroller 10 may also be used as a child's push toy.

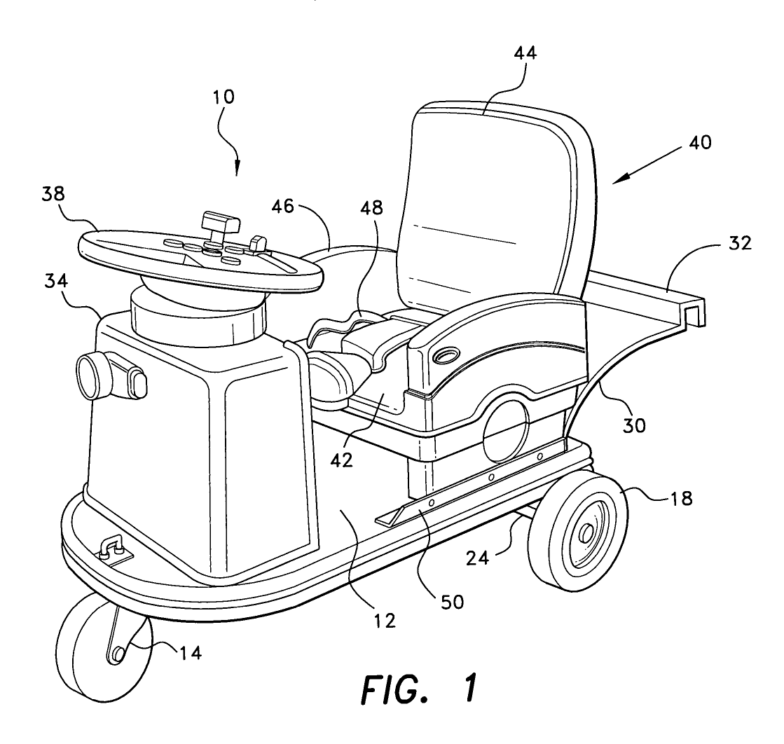

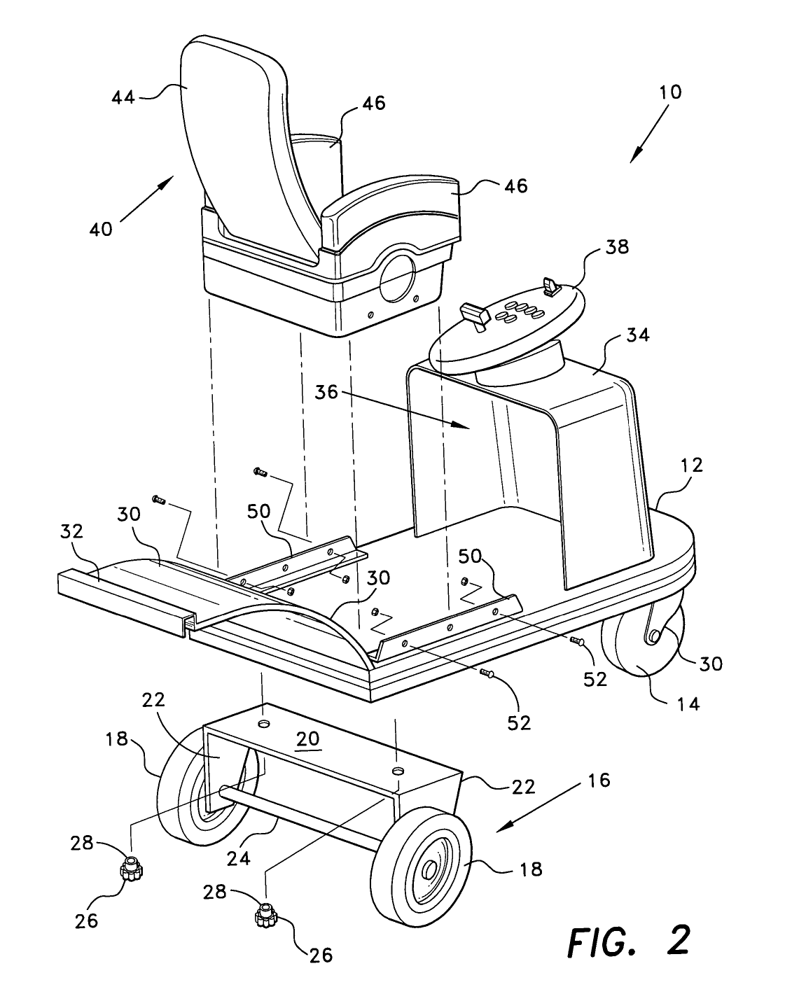

Referring to FIGS. 1 and 2, the multifunction stroller has a frame defined by a planar base platform 12. Three wheels are mounted to the bottom of the platform 12, including a swiveling front caster wheel 14 and a rear wheel assembly 16 having a pair of rear wheels 18. The rear wheel assembly 16 includes an inverted, U-shaped mounting frame formed by cross-member 20 and opposing struts 22, in which common wheel axle 24 is mounted. The U-shaped mounting frame is secured to the platform 12 by hand-operated twist knobs 26, which have a hollow, internally threaded shaft 28 that engage threaded studs (not shown) depending from the bottom surface of the platform 12. Thus, the rear wheel assembly 16 may be easily removed from the base platform 12 without tools for a purpose described below. The swiveling front caster wheel 14 enables the stroller 10 to be turned in any desired direction. It will be understood that although the stroller 10 is depicted with a single front caster wheel 14, that multiple front caster wheels are within the scope of the claimed invention.

A spoiler 30 extends rearward from the base platform 12. The spoiler 30 is formed by a thin, wide, arcuate plate having a first end attached to the rear of the platform 12 and a second end terminating in an inverted, U-shaped channel 32. Viewed from the side, the spoiler 30 forms approximately a 90° arc, although the degree of curvature is not critical to the invention. The width of the spoiler 30 extends across substantially the entire width of the rear of the platform 12.

A leg shroud 34 is fixed to the top surface of the platform 12 adjacent the front end. The leg shroud 34 may be formed by a front wall, opposing sidewalls, and a top wall, which, in combination with the top surface of the platform, define a well 36 dimensioned and configured for protecting the child's knees feet and shins when seated in the stroller 10. A simulated steering wheel 38 may be mounted on the top wall of the leg shroud 24. The steering wheel 38 is not connected to a steering linkage, but is provided for the child's amusement. The steering wheel may have a plurality of buttons, knobs and levers projecting there from for the child's diversion.

A seat 40 is mounted on the platform 12 between the leg shroud 34 and the spoiler 30. The seat 40 includes at least a horizontal member 42 and a backrest 44. The seat may also include armrests 46. The seat 40 also preferably includes a seat belt 48, shoulder harness (not shown), or other safety restraint for the child's protection. The backrest 44 may be attached to the seat 40 by a hinge, so that the backrest 44 may be rotated forward against horizontal member 42, or rearward against spoiler 30, for compact storage and transport.

The seat 40 may be rigidly attached to the platform 12, or optionally may be slidably attached to the platform 12. FIG. 2 shows a pair of opposing side rails 50 attached to the top surface of the platform 12, the bottom of the chair being attached to the rails 50 by screws 52. The position of the seat 40 may be adjusted forward and rearward by providing the side rails 50 with a plurality of holes, and aligning the holes in the base of the seat 50 with the holes in the side rails 50. Alternatively, a pair of opposing tracks may be mounted on the platform 12 and a pair of mating runners may be mounted on the base of seat 50 for sliding adjustment, similar to an automobile car seat.

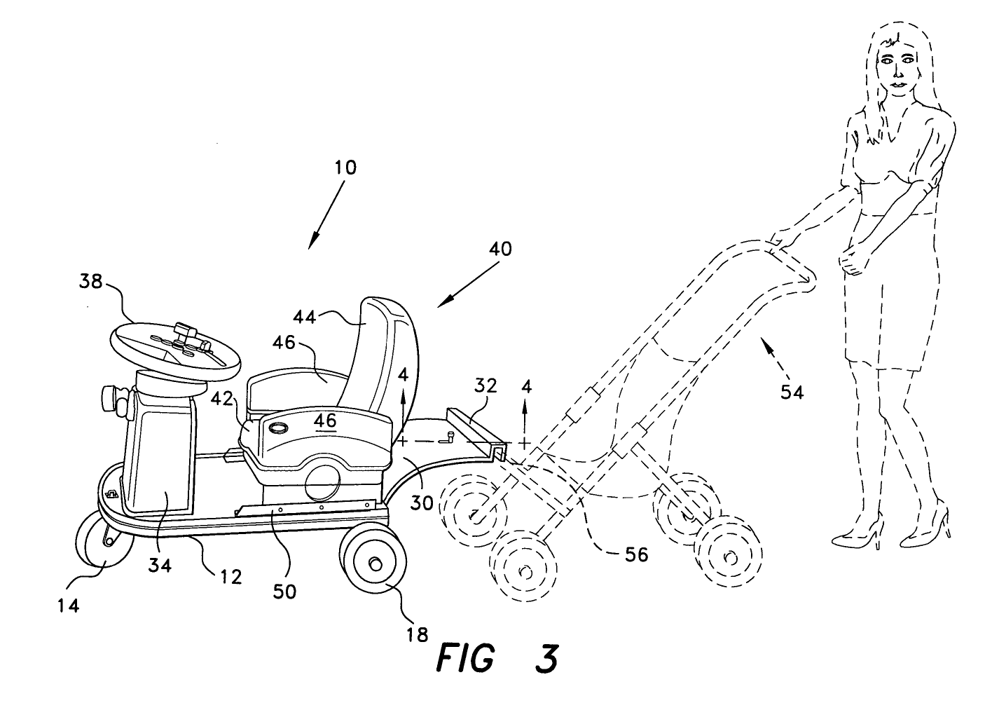

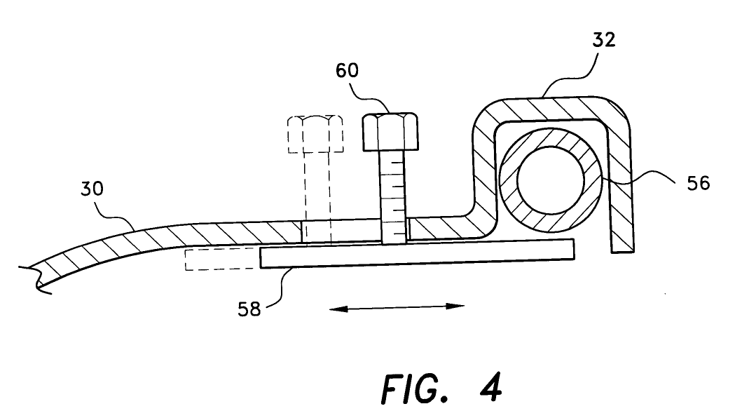

FIGS. 3 and 4 illustrate attachment of the multifunction stroller 10 to a conventional stroller 54 or other device having a relatively high horizontally extending front rail 56. Channel 32 is placed over the front rail of conventional stroller 54. A clamp plate 58 which extends under the channel 32 and the upper end of spoiler 30 is placed under the front rail and is secured by one or more thumb screws 60 extending through the upper end of spoiler 30 and into threaded apertures in the clamp plate 58. Clamp late 58 may extend across the entire width of spoiler 30, or several discrete clamp plates may be spaced apart across spoiler 30.

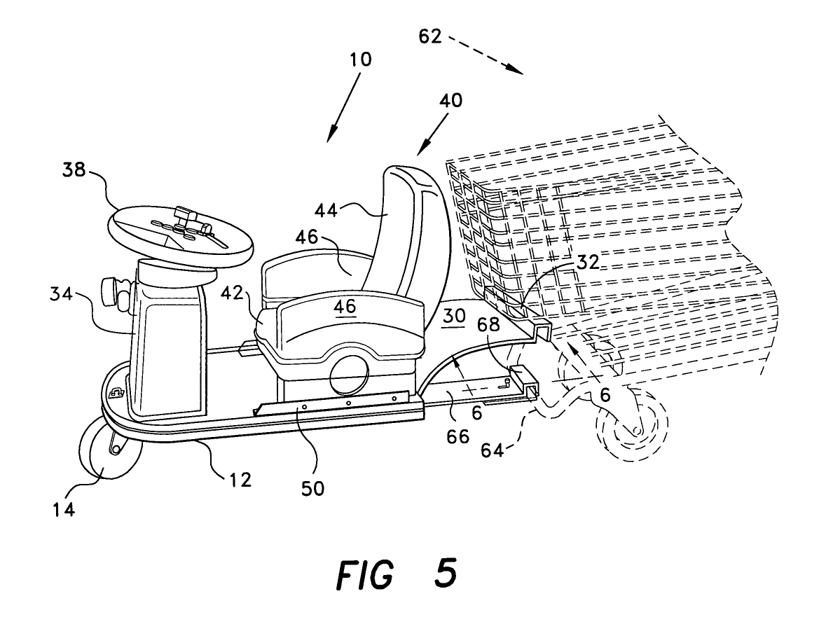

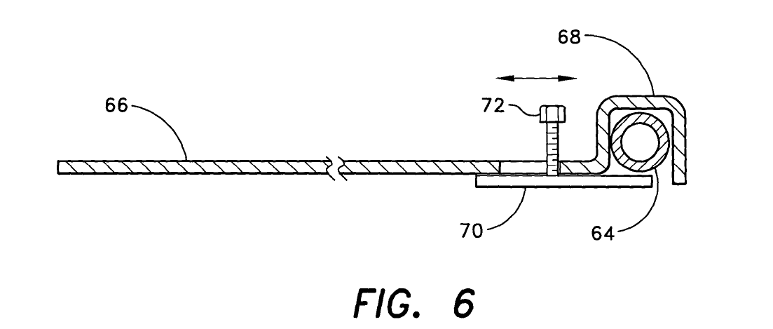

FIGS. 5 and 6 show the multifunction stroller attached to a grocery cart 62 or other device having a relatively low level horizontally extending front rail 64. In this configuration, an auxiliary planar extension plate 66 is removably attached to the rear of base platform 12, e.g., by thumb screws, beneath spoiler 30 and extends substantially coplanar with base platform 12. The auxiliary extension plate 66 may be attached to the base platform 12 by removing rear wheel assembly 16 and installing the auxiliary extension plate 66 in its place by removing and re-installing hand operated knobs 26, so that no tools are required. Auxiliary extension plate 66 terminates in an inverted U-shaped channel 68, similar to channel 32. The auxiliary extension plate 66 is secured to the grocery cart in the same manner that spoiler 32 is attached to conventional stroller 54, i.e., channel 68 is placed over front rail 64 and secured by a clamp plate 70 placed beneath the channel 68 and front rail 64, a thumb screw 72 being inserted through a hole in auxiliary extension plate 66 and secured in a threaded aperture in clamp plate 70.

As shown in FIG. 5, in this configuration the rear wheel assembly 16 may be removed from the platform 12 using twist knobs 26. Removal of the rear wheel assembly 16 may aid in steering the tandem assembly of multifunction stroller 10 and grocery cart 62.

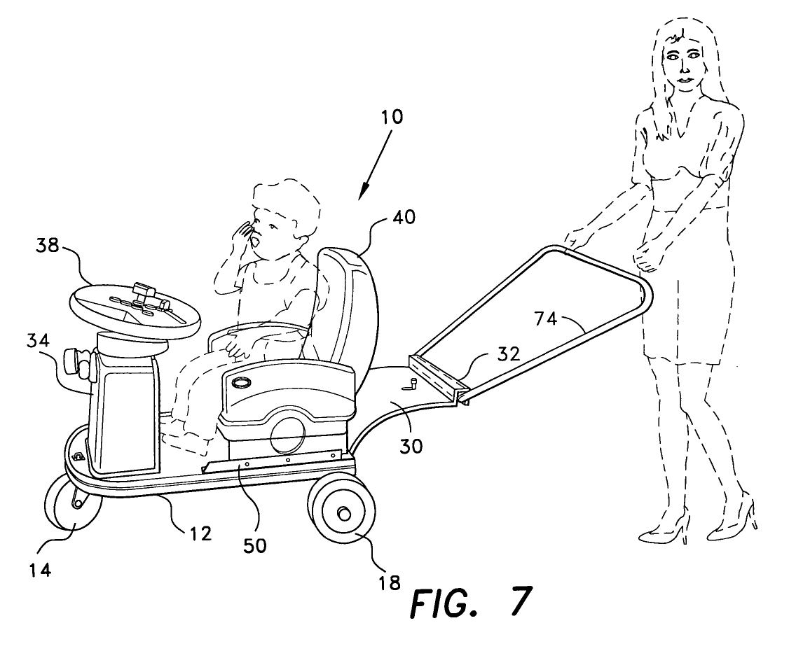

FIG. 7 shows the multifunction stroller 10 configured for use as a stand alone stroller. This is accomplished by attaching a handlebar assembly 74 to the spoiler 30. The handlebar assembly 74 may be, e.g., a rectangular loop formed from tubing. The handlebar assembly 74 is attached to the spoiler 30 in the same manner as shown and described with reference to FIG. 4. The handlebar assembly 74 may be equipped with rubber sleeves or the like which frictionally engage the inner walls of channel 32 in order to prevent rotation of the handlebar assembly 74 in channel 32, thereby maintaining the handlebar assembly 74 in an upright position.

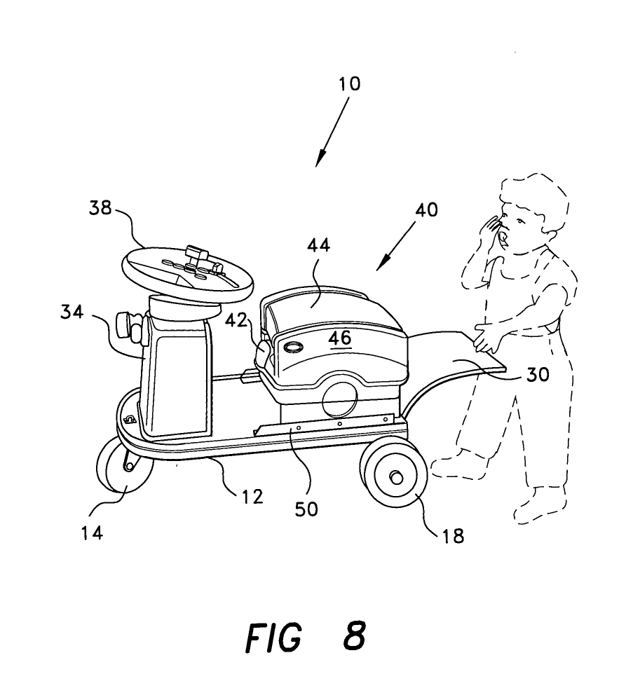

FIG. 8 shows the multifunction stroller 10 in use as a child's push toy. The child may push the stroller 10 by grasping the free end of the spoiler 30 and using the spoiler to push and steer the stroller 10. In this configuration, the backrest 44 may be collapsed against the horizontal member 42 of seat 40 to provide a toddler with visibility.

The multifunction stroller 10 may be made with metal parts, with molded or extruded plastic parts, or a combination thereof.

Hence, the multifunction stroller 10 of the present invention provides a versatile addition to the stroller art.

It is to be understood that the present invention is not limited to the embodiments described above, but encompasses any and all embodiments within the scope of the following claims.

1. A multifunction stroller, comprising:
a base platform having a top surface, a front end and a rear end;
at least one front wheel attached to said platform;
a rear wheel assembly removably attached to said platform;
a seat attached to the top surface of said platform, the seat being adapted for accommodating a child;
a spoiler extending from the rear end of said platform, the spoiler being a thin, wide, arcuate plate having a first end attached to said platform and an inverted U-shaped channel defining an opposite second end, the second end being arched above and rearward of said platform; and
a clamp plate removably attached across said U-shaped channel;
whereby the spoiler is alternately adapted for attaching the multifunction stroller to a front end of a second stroller for operation in tandem, and for attachment of a handlebar assembly for operation as a stand alone stroller.

2. The multifunction stroller according to claim 1, further comprising a leg shroud attached to the top surface of said platform at the front end, the leg shroud having a front wall, a top wall and two opposing sidewalls joined to the front wall and the top wall, the shroud defining a well adapted for protecting the child's legs.

3. The multifunction stroller according to claim 2, further comprising a simulated steering wheel attached to the top wall of said shroud for amusing the child.

4. The multifunction stroller according to claim 1, wherein said at least one front wheel comprises a swiveling caster wheel.

5. The multifunction stroller according to claim 1, wherein said at least one front wheel consists of a single swiveling caster wheel.

6. The multifunction stroller according to claim 1, wherein said rear wheel assembly comprises:
an inverted U-shaped frame having a cross member and opposing struts depending from the cross member;
a common axle having opposing ends mounted in the opposing struts; and
a rear wheel mounted on each of the opposing ends of the axle.

7. The multifunction stroller according to claim 6, further comprising a pair of twist knobs, each twist knob having a hollow, internally threaded shaft, the twist knobs being removably attached to said platform in order to removably secure said rear wheel assembly to said platform.

8. The multifunction stroller according to claim 7, further comprising:
an auxiliary, planar extension plate having a first end removably attached to said base platform, the auxiliary extension plate extending from the rear end of said platform below said spoiler and having an inverted, U-shaped channel defining an opposing second end; and
an auxiliary clamp plate removably attached to the extension plate and extending across the channel at the second end of the extension plate;
wherein the extension plate is attachable to said platform by removing said rear wheel assembly from said platform and securing the extension plate to said platform with said twist knobs;
whereby the extension plate is adapted for attaching the multifunction stroller to a horizontal rail at a front end of a grocery cart for tandem operation therewith.

9. The multifunction stroller according to claim 1, wherein said seat comprises a horizontal member and a backrest pivotally attached to the horizontal member, whereby the backrest is foldable against the horizontal member for compact storage and transport.

10. The multifunction stroller according to claim 1, further comprising a pair of opposing, parallel, elongated side rails mounted to the top surface of said platform, the side rails having a plurality of spaced apart apertures defined therein, said seat being mounted to said side rail, said seat being mounted toward the front end and the rear end by aligning the seat with the apertures in the side rails in order to accommodate the child's leg length.

11. The multifunction stroller according to claim 1, further comprising means for restraining the child in said seat.

12. The multifunction stroller according to claim 1, further comprising a seat belt attached to said seat.

13. The multifunction stroller according to claim 1, further comprising a safety harness attached to said seat.

14. The multifunction stroller according to claim 1, wherein said stroller has a curvature of about 90°.

15. The multifunction stroller according to claim 1, further comprising a handlebar, the handlebar being a substantially rectangular loop made of tubular material, the loop having one side disposed in the channel at the second end of said spoiler and removably secured therein by said clamp plate, whereby the multifunction stroller is configured as a stand alone stroller.

16. A multifunction stroller, comprising:
a base platform having a top surface, a front end and a rear end;
at least one front wheel attached to said platform;
a rear wheel assembly removably attached to said platform;
a seat attached to the top surface of said platform, the seat being adapted for accommodating a child;
means extending from the rear end of the platform for alternatively attaching the platform to another push vehicle or to a handlebar assembly;
whereby the spoiler is alternately adapted for attaching the multifunction stroller to a front end of a push vehicle for operation in tandem, and for attachment of a handlebar assembly for operation as a stand alone stroller.

17. A multifunction stroller, comprising:
a base platform having a top surface, a front end and a rear end;
at least one front caster wheel attached to said platform;
a rear wheel assembly removably attached to said platform;
a seat attached to the top surface of said platform, the seat being adapted for accommodating a child;
a spoiler extending from the rear end of said platform, the spoiler being a thin, wide, arcuate plate having a first end attached to said platform and an inverted U-shaped channel defining an opposite second end, the second end being arched above and rearward of said platform;
a handlebar, the handlebar being a rectangular loop made from tubular material having a side disposable within the channel defined in the second end of the spoiler;
means for clamping the handlebar or adapted for clamping a horizontal rail at a front end of a second stroller within the channel defined in the second end of the spoiler;
an auxiliary extension plate removably attached to said platform, the extension plate being planar and extending rearward from said platform below said spoiler, the extension plate having an inverted U-shaped channel attached thereto adapted for receiving a horizontal rail at a front end of a grocery cart;
whereby the multifunction stroller is convertible between attachment to the second stroller or grocery cart for operation in tandem, and use as a stand alone stroller.
